(19) United States
(12) Patent Application Publication
(10) Pub. No.: US 2016/0322867 A1
(43) Pub. Date: Nov. 3, 2016

(54) WIRELESS ELECTRIC/MAGNETIC FIELD POWER TRANSFER SYSTEM, TRANSMITTER AND RECEIVER

(71) Applicants: Nagesh POLU, St. John's (CA); Andrew BARTLETT, St. Johns (CA)

(72) Inventors: Nagesh POLU, St. John's (CA); Andrew BARTLETT, St. Johns (CA)

(21) Appl. No.: 14/747,588

(22) Filed: Jun. 23, 2015

Related U.S. Application Data
(60) Provisional application No. 62/155,844, filed on May 1, 2015.

(51) Int. Cl. H02J 50/12; H02J 50/05

(52) U.S. Cl. CPC H02J 50/12; H02J 50/05

(57) ABSTRACT

A hybrid resonator comprises capacitive electrodes; and an induction coil electrically connected to the capacitive electrodes. The capacitive electrodes and the induction coil are configured to: responsive to a generated field, extract power from the generated field; and responsive to the extracted power, generate a field.

### CROSS REFERENCE TO RELATED APPLICATION

This application claims the benefit of U.S. Provisional Application No. 62/155,844 filed May 1, 2015 and is related to U.S. patent application Ser. No. 13/607,474 filed on Sep. 7, 2012, the entire contents of which are incorporated herein by reference.

### FIELD

The subject application relates generally to wireless power transfer and in particular, to a wireless electric or magnetic field power transfer system, a transmitter and receiver therefor and a method of wirelessly transferring power.

### BACKGROUND

A variety of wireless power transfer systems are known. A typical wireless power transfer system includes a power source electrically connected to a wireless power transmitter, and a wireless power receiver electrically connected to a load. In magnetic induction systems, the transmitter has an induction coil that transfers electrical energy from the power source to an induction coil of the receiver. Power transfer occurs due to coupling of magnetic fields between the induction coils of the transmitter and receiver. The range of these magnetic induction systems is limited and the induction coils of the transmitter and receiver must be in optimal alignment for power transfer. There also exist resonant magnetic systems in which power is transferred due to coupling of magnetic fields between the induction coils of the transmitter and receiver. However, in resonant magnetic systems the induction coils are resonated using at least one capacitor. The range of power transfer in resonant magnetic systems is increased over that of magnetic induction systems and alignment issues are rectified.

In electrical induction systems, the transmitter and receiver have capacitive electrodes. Power transfer occurs due to coupling of electric fields between the capacitive electrodes of the transmitter and receiver. Similar, to resonant magnetic systems, there exist resonant electric systems in which the capacitive electrodes of the transmitter and receiver are made resonant using at least one inductor. Resonant electric systems have an increased range of power transfer compared to that of electric induction systems and alignment issues are rectified.

Although wireless power transfer techniques are known, improvements are desired. It is therefore an object to provide a novel wireless electric or magnetic field power transfer system, a transmitter and receiver therefor and a method of wirelessly transmitting power.

### SUMMARY

Accordingly, in one aspect there is provided a hybrid resonator comprising: capacitive electrodes; and an induction coil electrically connected to the capacitive electrodes, wherein the capacitive electrodes and the induction coil are configured to: responsive to a generated field, extract power from the generated field; and responsive to the extracted power, generate a field.

In one embodiment, the induction coil is an air core inductor.

In one embodiment, the capacitive electrodes form a capacitor.

In one embodiment, the capacitive electrodes are two laterally spaced electrodes, each of which is connected to either end of the induction coil.

In one embodiment, the generated field is a magnetic field.

In one embodiment, the generated field is an electric field.

In one embodiment, the field generated by the hybrid resonator is a resonant magnetic field.

In one embodiment, the field generated by the hybrid resonator is a resonant electric field.

According to another aspect there is provided a wireless power system comprising: a field-generator for generating a field; a hybrid resonator comprising: capacitive electrodes; and an induction coil electrically connected to the capacitive electrodes, wherein the capacitive electrodes and the induction coil are configured to: responsive to the generated field, extract power from the generated field; and responsive to the extracted power, generate a field; and a field-extractor for extracting power from the field generated by the hybrid resonator.

According to another aspect there is provided a transmitter comprising: a field-generator for generating a field; and a hybrid resonator comprising: capacitive electrodes; and an induction coil electrically connected to the capacitive electrodes, wherein the capacitive electrodes and the induction coil are configured to: responsive to the generated field, extract power from the generated field; and responsive to the extracted power, generated a field.

According to another aspect there is provided a receiver comprising: a hybrid resonator comprising: capacitive electrodes; and an induction coil electrically connected to the capacitive electrodes, wherein the capacitive electrodes and the induction coil are configured to: responsive to a generated field, extract power from the generated field; and responsive to the extracted power, generated a field; and a field-extractor for extracting power from the field generated by the hybrid resonator.

According to another aspect there is provided a resonator configured to extract and transfer power via electric and magnetic field coupling.

### BRIEF DESCRIPTION OF THE DRAWINGS

Embodiments will now be described more fully with reference to the accompanying drawings in which:

FIG. 1 is a block diagram of a wireless power transfer system;

FIG. 2 is a schematic layout of a wireless magnetic field power transfer system;

FIG. 3 is a schematic layout of a wireless resonant magnetic field power transfer system;

FIG. 4 is a schematic layout of a wireless electric field power transfer system;

FIG. 5 is a schematic layout of a wireless resonant electric field power transfer system;

FIG. 6 is a schematic layout of a wireless power transfer system;

FIG. 7 is a schematic layout of the hybrid wireless resonator of the system of FIG. 6;

FIG. 8 is a Smith chart showing wireless electric field power transfer system impedance requirements of the system of FIG. 6;

FIG. 9 is a schematic layout of another wireless power transfer system;

FIG. 10 is a Smith chart showing wireless magnetic field power transfer system impedance requirements of the system of FIG. 9;

FIG. 11 is a schematic layout of another wireless power transfer system;

FIG. 12 is a schematic layout of another wireless power transfer system;

FIG. 13 is a schematic layout of another wireless power transfer system;

FIG. 14 is a Smith chart showing wireless electric and magnetic field power transfer system impedance requirements of the system of FIG. 13;

FIG. 15 is a schematic layout of the power transfer system of FIG. 13 in another configuration;

FIG. 16 is a Smith chart showing wireless electric and magnetic field power transfer system impedance requirements of the system of FIG. 15;

FIG. 17 is a graph of wireless magnetic field power transfer system power efficiency vs. frequency of the system of FIG. 15;

FIG. 18 is a schematic layout of the power transfer system of FIG. 13 in another configuration;

FIG. 19 is a Smith chart showing wireless electric and magnetic field power transfer system impedance requirements of the system of FIG. 18;

FIG. 20 is a graph of wireless electric field power transfer system power efficiency vs. frequency of the system of FIG. 18;

FIG. 21 is a schematic layout of another embodiment of a hybrid wireless resonator; and

FIG. 22 is a schematic layout of another embodiment of a hybrid wireless resonator.

### DETAILED DESCRIPTION OF EMBODIMENTS

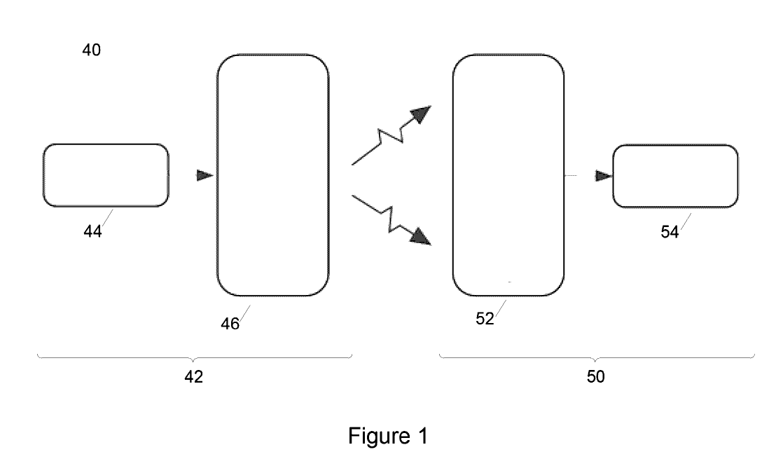

Turning now to FIG. 1, a wireless power transfer system is shown and is generally identified by reference numeral 40. The wireless power transfer system 40 comprises a transmitter 42 comprising a power source 44 electrically connected to a transmit element 46, and a receiver 50 comprising a receive element 52 electrically connected to a load 54. Power is transferred from the power source 44 to the transmit element 46. The power is then transferred from the transmit element 46 to the receive element 52 via resonant or non-resonant electric or magnetic field coupling. The power is then transferred from the receive element 52 to the load 54.

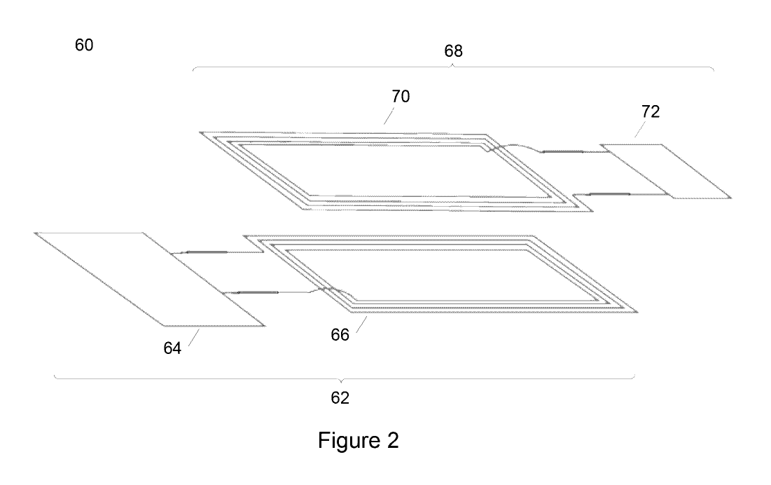

In one example, the wireless power transfer system may take the form of a non-resonant magnetic field wireless power transfer system as shown in FIG. 2 and generally identified by reference numeral 60. The non-resonate magnetic field wireless power transfer system 60 comprises a transmitter 62 comprising a power source 64 electrically connected to a transmit induction coil 66, and a receiver 68 comprising a receive induction coil 70 electrically connected to a load 72. In this embodiment, the power source 64 is an RF power source. During operation, power is transferred from the power source 64 to the transmit induction coil 66 of the transmitter 62. In particular, current from the power source 64 causes the transmit induction coil 66 to generate a magnetic field. When the receive induction coil 70 is placed within the magnetic field, a current is induced in the receive induction coil 70 thereby extracting power from the transmitter 62. The extracted power is then transferred from the receive induction coil 70 to the load 72. As the power transfer is non-resonant, efficient power transfer between the transmitter 62 and receiver 68 requires that the transmit and receive induction coils 66 and 70 be close together and in close alignment.

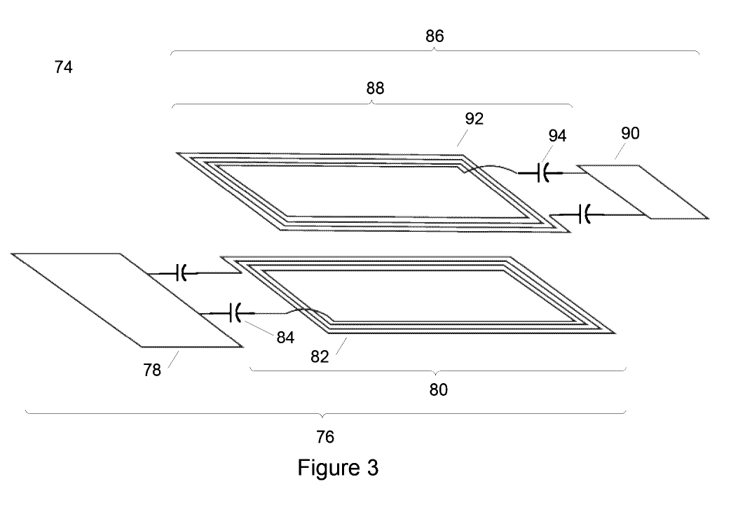

In another example, the wireless power transfer system takes the form of a resonant magnetic field wireless power transfer system as shown in FIG. 3 and generally identified by reference numeral 74. The resonate magnetic field wireless power transfer system 74 comprises a transmitter 76 comprising a power source 78 electrically connected to a transmit resonator 80. The transmit resonator 80 comprises a transmit induction coil 82 and a pair of transmit high Quality Factor (Q) capacitors 84, each of which is electrically connected to the power source 78 and to one end of the transmit induction coil 82. The system 74 further comprises a receiver 86 comprising a receive resonator 88 electrically connected to a load 90. The receive resonator 88 comprises a receive induction coil 92 and a pair of receive high Q capacitors 94, each of which is electrically connected to the load 90 and to one end of the receive induction coil 92. During operation, power is transferred from the power source 78 to the transmit induction coil 82 of the transmit resonator 80 via the transmit capacitors 84 causing the transmit resonator 80 to generate a resonant magnetic field. When the receiver 86 is placed within the magnetic field, the receive resonator 88 extracts power from the transmitter 76 via resonant magnetic field coupling. The extracted power is then transferred from the receive resonator 88 to the load 90 via the high Q capacitors 94. As the power transfer is resonant, the transmit and receive induction coils 82 and 92 need not be as close together or as well aligned as is the case with the non-resonant system 60 of FIG. 2.

While the capacitors 84 and 94 are shown as being connected in series to the power source 78 and load 90, respectively, in FIG. 3, one of skill in the art will appreciate that the capacitors 84 and 94 may be connected to the power source 78 and load 90, respectively, in parallel.

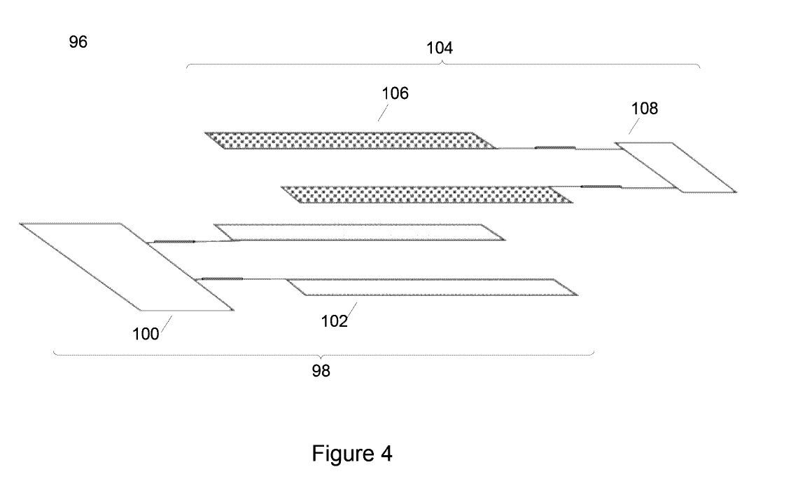

In another example the wireless power transfer system takes the form of a non-resonant electric field wireless power transfer system as shown in FIG. 4 and generally identified by reference numeral 96. The non-resonant electric field wireless power transfer system 96 comprises a transmitter 98 comprising a power source 100 electrically connected to a pair of laterally spaced, elongate transmit capacitive electrodes 102, and a receiver 104 comprising a pair of laterally spaced, elongate receive capacitive electrodes 106 electrically connected to a load 108. During operation, the power signal from the power source 100 produces a voltage difference between the transmit capacitive electrodes 102 causing the transmit capacitive electrodes 102 to generate an electric field. When the receive capacitive electrodes 106 are placed within the electric field, a voltage is induced between the receive capacitive electrodes 106 thereby extracting power from the transmitter 98. The extracted power is then transferred from the receive capacitive electrodes 106 to the load 108. As the power transfer is non-resonant, efficient power transfer between the transmitter 98 and receiver 104 requires that the transmit and receive capacitive electrodes 102 and 106 be close together and in close alignment.

In this embodiment, each transmit and receive capacitive electrode 102 and 106 comprises an elongate element formed of electrically conductive material. The conductive elements are in the form of generally rectangular, planar plates. While the transmit capacitive electrodes 102 and receive capacitive electrodes 106 have been described as laterally spaced, elongate electrodes, one of skill in the art will appreciate that other configurations are possible including, but not limited to, concentric, coplanar, circular, elliptical, disc, etc., electrodes. Other suitable electrode configurations are described in U.S. Provisional Application No. 62/046,830 to Nyberg et al. filed on Sep. 5, 2014, the relevant portions of which are incorporated herein by reference.

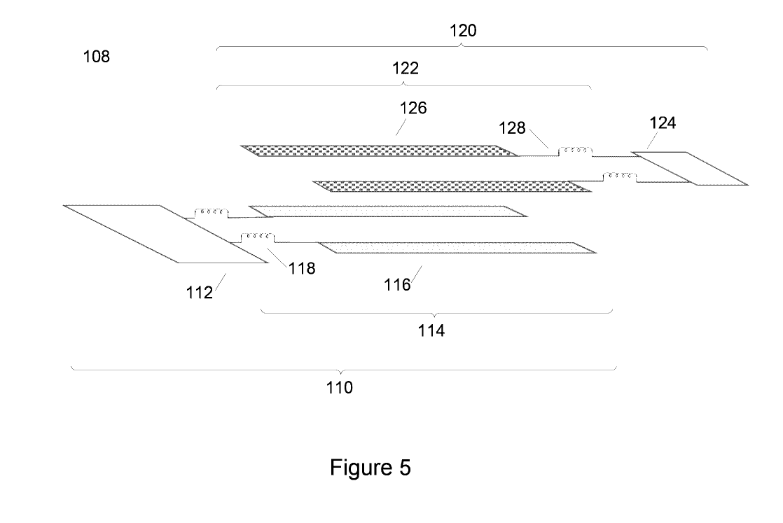

In another example the wireless power transfer system 40 takes the form of a resonant electric field wireless power transfer system as shown in FIG. 5 and generally identified by reference numeral 108 such as that described in U.S. patent application Ser. No. 13/607,474 to Polu et al. filed on Sep. 7, 2012, the relevant portions of which are incorporated herein by reference. The resonant electric field wireless power transfer system 108 comprises a transmitter 110 comprising a power source 112 electrically connected to a transmit resonator 114. The transmit resonator 114 comprises a pair of laterally spaced, elongate transmit capacitive electrodes 116, each of which is electrically connected to the power source 112 via a transmit high Q inductor 118. The system 108 further comprises a receiver 120 comprising a receiver resonator 122 electrically connected to a load 124. The receive resonator 122 is tuned to the resonant frequency of the transmit resonator 114. The receive resonator 122 comprises a pair of laterally spaced, elongate receive capacitive electrodes 126, each of which is electrically connected to the load 124 via a receive high Q inductor 128. In this embodiment, the inductors 118 and 128 are ferrite core inductors. One of skill in the art however will appreciate that other cores are possible.

During operation, power is transferred from the power source 112 to the transmit capacitive electrodes 116 via the transmit high Q inductors 118. In particular, the power signal from the power source 112 that is transmitted to the transmit capacitive electrodes 116 via the transmit high Q inductors 118 excites the transmit resonator 114 causing the transmit resonator 114 to generate a resonant electric field. When the receiver 120 is placed within the resonant electric field, the receive resonator 122 extracts power from the transmitter 110 via resonant electric field coupling. The extracted power is then transferred from the receive resonator 122 to the load 124. As the power transfer is highly resonant, the transmit and receive capacitive electrodes 116 and 126 need not be as close together or as well aligned as is the case with the non-resonant system 96 of FIG. 4.

In this embodiment, each transmit and receive capacitive electrode 116 and 126 comprises an elongate element formed of electrically conductive material. The conductive elements are in the form of generally rectangular, planar plates.

While the transmit capacitive electrodes 102 and receive capacitive electrodes 106 have been described as laterally spaced, elongate electrodes, one of skill in the art will appreciate that other configurations are possible including, but not limited to, concentric, coplanar, circular, elliptical, disc, etc., electrodes. Other suitable electrode configurations are described above-incorporated in U.S. Provisional Application No. 62/046,830.

While the inductors 118 and 128 are shown as being connected in series to the power source 112 and the load 124, respectively, in FIG. 5, one of skill in the art will appreciate that the inductors 118 and 128 may be connected to the power source 112 and the load 124, respectively, in parallel.

As will be appreciated, the components of magnetic non-resonant and resonant power transfer systems 60 and 74, respectively, are not compatible with the components of electric non-resonant and resonant power transfer systems 96 and 108, respectively. The systems 60 and 74 transfer power via non-resonant and resonant magnetic field coupling, respectively, while the systems 96 and 108 transfer power via non-resonant and resonant electric field coupling, respectively, making interoperability of these systems not possible.

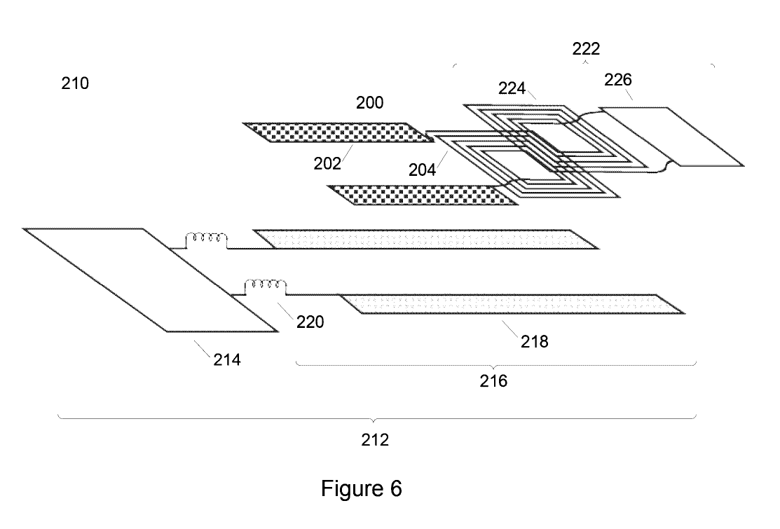

An exemplary wireless power transfer system is shown in FIG. 6 and is generally identified by reference character 210. The system 210 comprises a transmitter 212 comprising a power source 214 electrically connected to a transmit resonator 216. The transmit resonator 216 comprises a pair of laterally spaced, elongate transmit capacitive electrodes 218, each of which is electrically connected to the power source 214 via a transmit high Q inductor 220. The system 210 further comprise a receiver 222 comprising a receive induction coil 224 electrically connected to a load 226. The system 210 further comprises a hybrid resonator 200 comprising two capacitive electrodes 202 and an induction coil. Each capacitive electrode 202 is electrically connected to one end of the induction coil 204. The capacitive electrodes 202 form a capacitor. The hybrid resonator 200 is tuned to the resonant frequencies of the transmit resonator 216 and receive induction coil 224.

In this embodiment, each capacitive electrode 202 and transmit capacitive electrode 218 comprises an elongate element formed of electrically conductive material. The conductive elements are in the form of generally rectangular, planar plates. Furthermore, in this embodiment, the induction coil 204 and receive induction coil 224 are air core inductors. In this embodiment, the inductors 220 are ferrite core inductors. One of skill in the art will however, appreciate that other cores are possible. One of skill in the art will also appreciate that the hybrid resonator 200 may be integral with or separate from the transmitter 212 and/or the receiver 222.

During operation, power is transferred from the power source 214 to the transmit capacitive electrodes 218 via the transmit inductors 220. The power signal from the power source 214 excites the transmit resonator 216 causing the transmit resonator 216 to generate a resonant electric field. When the hybrid resonator 200 is placed within the electric field, the capacitive electrodes 202 of the hybrid resonator extract power from the transmitter 212 via resonant electric field coupling. The extracted power excites the hybrid resonator 200 causing the capacitive electrodes 202 and the induction coil 204 to resonate. The induction coil 204 in turn generates a resonant magnetic field. When the receiver 222 is placed within the generated resonant magnetic field of the hybrid resonator 200, a current is induced in the receive induction coil 224 thereby extracting power from the hybrid resonator 200. The extracted power is then transferred from the receive induction coil 224 to the load 226.

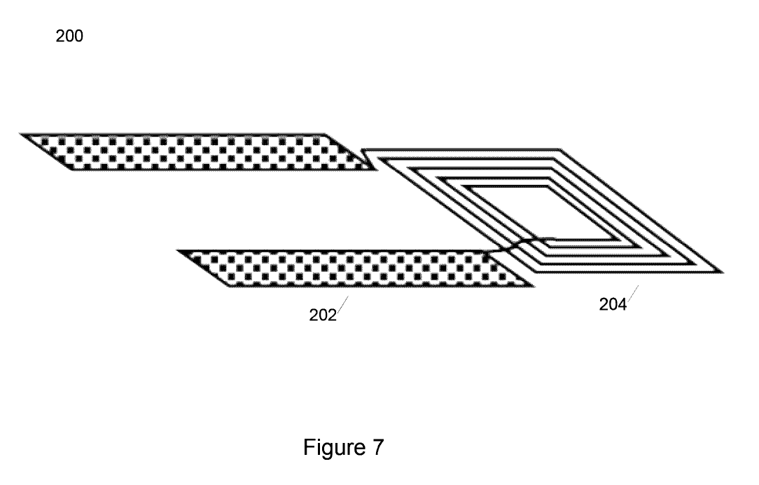

Turning now to FIG. 7 the hybrid resonator 200 of FIG. 6 is shown in isolation. As previously stated, the hybrid resonator 200 comprises two capacitive electrodes 202 and the induction coil 204. Each capacitive electrode 202 is electrically connected to one end of the induction coil 204.

In use, when the hybrid resonator 200 has extracted power from a transmitter, the capacitive electrodes 202 and the induction coil 204 resonate thereby causing the capacitive electrodes 202 to generate a resonant electric field with the induction coil 204 to generate a resonant magnetic field with the capacitive electrodes 202 acting as a capacitor. When a receiver comprising capacitive electrodes is placed within the resonant electric field, power is extracted from the hybrid resonator 200 via resonant electric field coupling. When a receiver comprising an induction coil is placed within the resonant magnetic field, power is extracted from the hybrid resonator 200 via resonant magnetic field coupling. The capacitive electrodes 202 and induction coil 204 are tuned to the resonant field of the respective receiver.

The hybrid resonator 200 is used in systems to facilitate power transfer between transmitters/receivers which operate via magnetic and resonant magnetic field coupling and receivers/transmitters which operate via electric and resonant electric field coupling or vice a versa.

Accordingly, the hybrid resonator 200 can be used to facilitate power transfer in a variety of systems that facilitate power transfer between transmitters and receivers. The transmitters may include: transmitter 62 which transfers power via non-resonant magnetic field coupling, transmitter 76 which transfers power via resonant magnetic field coupling, transmitter 98 which transfers power via non-resonant electric field coupling, or transmitter 110 which transfers power via resonant electric field coupling. The receivers may include receiver 68 which extracts power via non-resonant magnetic field coupling, receiver 86 which extracts power via resonant magnetic field coupling, receiver 104 which extracts power via non-resonant electric field coupling, or receiver 120 which extracts power via resonant electric field coupling.

Furthermore, one of skill in the art will appreciate that transmitters/receivers that transfer power via resonant magnetic field coupling may comprise one or more high Q capacitors, and transmitters/receivers that transfer power via resonant electric field coupling may comprise one or more inductors. Furthermore, the high Q capacitors and inductors may be variable or non-variable.

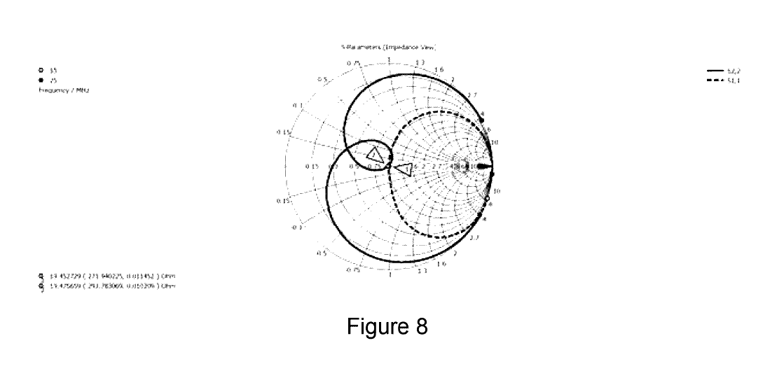

Electromagnetic field simulations using CST Microwave Studio software were performed to determine the impedance requirements of the wireless power transfer system 210 at a particular operating frequency. FIG. 8 shows the results of the electromagnetic field simulations for determining the impedance requirements of the system 210 at an operating frequency of approximately 19 MHz.

As shown in the Smith chart of FIG. 8, a frequency sweep from 15 to 25 MHz yields matched impedance between the transmitter 212 and receiver 222 in the electric field at the points marked 1 and 2. The lower impedance requirement from the Smith chart of FIG. 8 is at point 1 and is approximately 271 Ohms. The system 210 was configured such that this impedance was achieved.

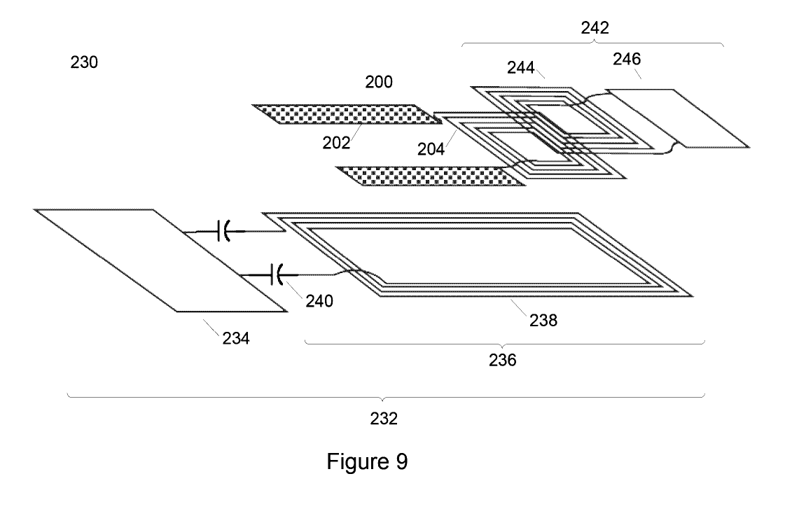

Another exemplary wireless power transfer system which comprises the hybrid resonator 200 is shown in FIG. 9 and is generally identified by reference numeral 230. The system 230 comprises a transmitter 232 comprising a power source 234 electrically connected to a transmit resonator 236. The transmit resonator 236 comprises a transmit induction coil 238 and a pair of transmit high Q capacitors 240, each of which is electrically connected to the power source 234 and to one end of the transmit induction coil 238. The system further comprise a receiver 242 comprising a receive induction coil 244 electrically connected to a load 246. The system 230 further comprises the hybrid resonator 200 as previously described. The hybrid resonator 200 is tuned to the resonant frequencies of the transmit resonator 236 and the receive induction coil 238. In this embodiment, the transmit and receive induction coils 238 and 244 are air core inductors. One of skill in the art will appreciate that the hybrid resonator 200 may be integral with or separate from the transmitter 232 or the receiver 242.

During operation, power is transferred from the power source 234 to the transmit induction coil 238 of the transmit resonator 236 via the transmit capacitors 240 causing the transmit resonator 236 to generate a resonant magnetic field. When the hybrid resonator 200 is placed within this field, the induction coil 204 of the hybrid resonator 200 extracts power from the transmitter 232 via resonant magnetic field coupling. The extracted power excites the hybrid resonator 200 causing the capacitive electrodes 202 and the induction coil 204 to resonate. The induction coil 204 in turn generates a resonant magnetic field. When the receiver 242 is placed within the generated resonant magnetic field of the hybrid resonator 200, a current is induced in the receive induction coil 244 thereby extracting power from the hybrid resonator 200. The extracted power is then transferred from the receive induction coil 244 to the load 246.

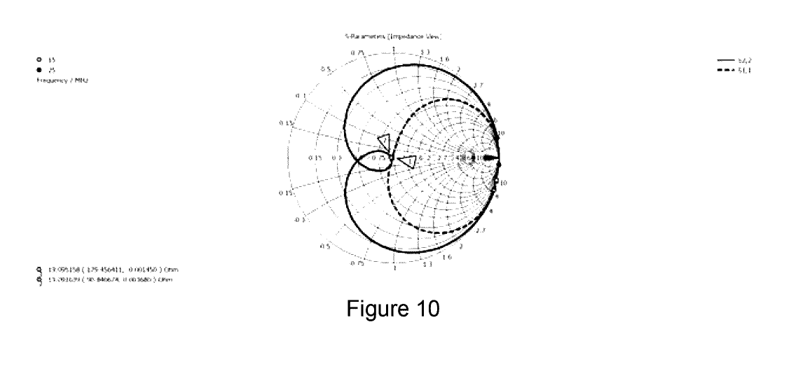

Electromagnetic field simulations using CST Microwave Studio software were performed to determine the impedance requirements of the wireless power transfer system 230 at a particular operating frequency. FIG. 10 shows the results of the electromagnetic field simulations for determining the impedance requirements of the system 230 at an operating frequency of approximately 19 MHz.

As shown in the Smith chart of FIG. 10, a frequency sweep from 15 to 25 MHz yields matched impedance between the transmitter 232 and receiver 242 in the magnetic field at the points marked 1 and 2. The lower impedance requirement from the Smith chart of FIG. 10 is at point 2 and is approximately 90 Ohms. The system 230 was configured such that this impedance was achieved.

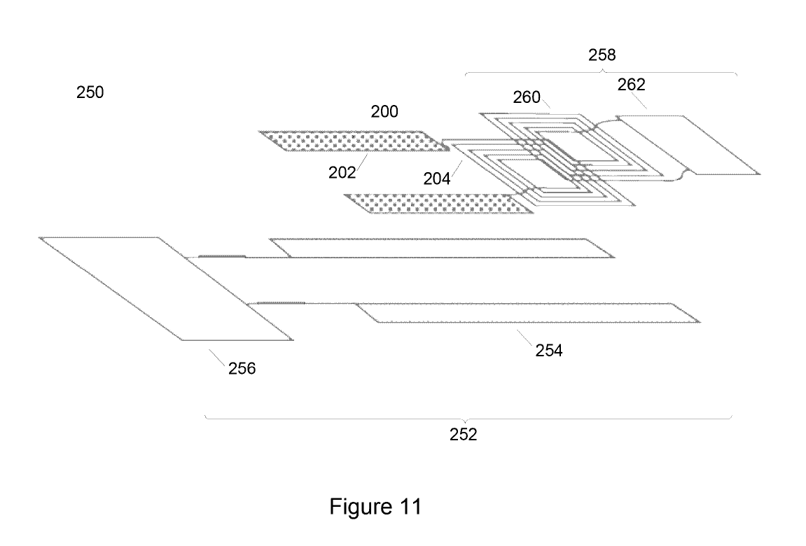

Another exemplary wireless power transfer system which comprises the hybrid resonator 200 is shown in FIG. 11 and is generally identified by reference character 250. The system comprises a transmitter 252 comprising a pair of laterally spaced, elongate transmit capacitive electrodes 254, each of which is electrically connected to a power source 256. The system further comprises a receiver 258 comprising a receive induction coil 260 electrically connected to a load 262. The system 250 further comprises the hybrid resonator 200 as previously described. The hybrid resonator 200 is tuned to the resonant frequency of the receive induction coil 260. In this embodiment, each transmit capacitive electrode 254 comprises an elongate element formed of electrically conductive material. The conductive elements are in the form of generally rectangular, planar plates. Furthermore, in this embodiment, the receive induction coil 260 is an air core inductor. One of skill in the art will appreciate that the hybrid resonator 200 may be integral with or separate from the transmitter 252 or the receiver 258.

During operation, the power signal from the power source 256 causes a voltage difference between the transmit capacitive electrodes 254 causing the transmit capacitive electrodes 254 to generate an electric field. When the capacitive electrodes 202 of the hybrid resonator 200 are placed within the generated electric field, a voltage is induced between the capacitive electrodes 202 of the hybrid resonator 200 thereby extracting power from the transmitter 252. The extracted power excites the hybrid resonator 200 causing the capacitive electrodes 202 and the induction coil 204 to resonate. The induction coil 204 in turn generates a resonant magnetic field. When the receiver 258 is placed within the generated resonant magnetic field of the hybrid resonator 200, a current is induced in the receive induction coil 260 thereby extracting power from the hybrid resonator 200. The extracted power is then transferred from the receive induction coil 260 to the load 262.

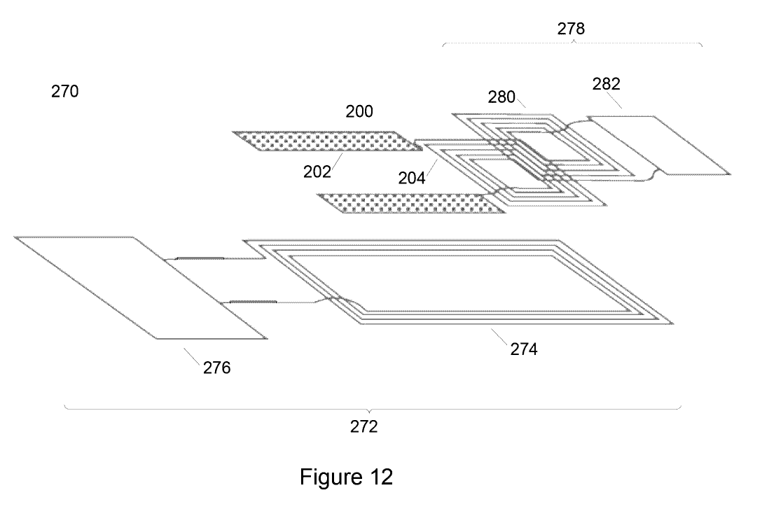

Another exemplary wireless power transfer system which comprises the hybrid resonator 200 is shown in FIG. 12 and is generally identified by reference character 270. The system comprises a transmitter 272 comprising a transmit induction coil 274 electrically connected, at either end of the transmit induction coil 274, to a power source 276. The system 270 further comprises a receiver 278 comprising a receive induction coil 280 electrically connected to a load 282. The system 270 further comprises the hybrid resonator 200 as previously described. The hybrid resonator 200 is tuned to the resonant frequency of the receive induction coil 280. Furthermore, in this embodiment, the transmit and receive induction coils 274 and 280 are air core inductors. One of skill in the art will appreciate that the hybrid resonator 200 may be integral with or separate from the transmitter 272 or the receiver 278.

During operation, current from the power source 276 causes the transmit induction coil 274 to generate a magnetic field. When the induction coil 204 of the hybrid resonator 200 is placed within the generated magnetic field, a current is induced in the induction coil 204 thereby extracting power from the transmitter 272. The extracted power excites the hybrid resonator 200 causing the capacitive electrodes 202 and the induction coil 204 to resonate. The induction coil 204 in turn generates a resonant magnetic field. When the receiver 278 is placed within the generated resonant magnetic field of the hybrid resonator 200, a current is induced in the receive induction coil 280 thereby extracting power from the hybrid resonator 200. The extracted power is then transferred from the receive induction coil 280 to the load 282.

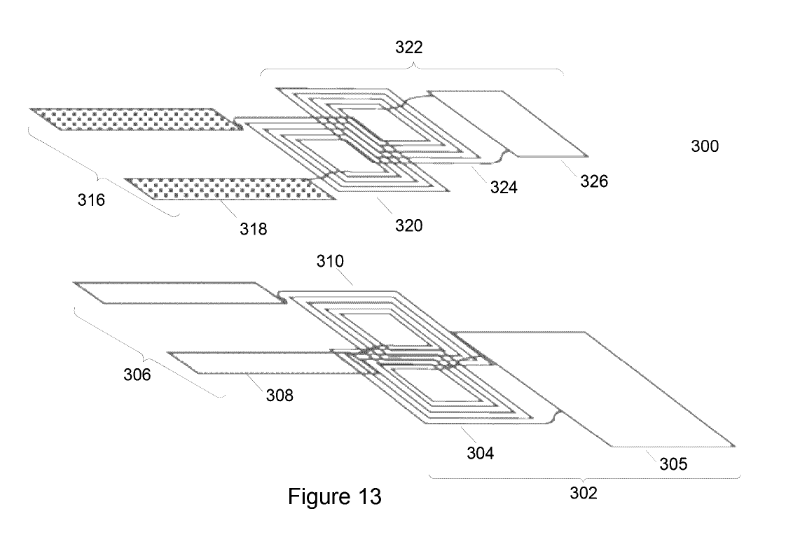

Another exemplary wireless power transfer system which comprises two hybrid resonators is shown in FIG. 13 and is generally identified by reference numeral 300. The system 300 comprises a transmitter 302, a first hybrid resonator 306, a second hybrid resonator 316 and a receiver 322. The transmitter 302 comprises a transmit induction coil 304 electrically connected, at either end of the transmit induction coil 304, to a power source 305. The first hybrid resonator 306 comprises first capacitive electrodes 308 which are electrically connected to either end of a first induction coil 310. The second hybrid resonator 316 comprises second capacitive electrodes 318 which are electrically connected to either end of a second induction coil 320. The receiver 322 comprises a receive induction coil 324 electrically connected, at either end of the receive induction coil 324, to a load 326. In this embodiment, each capacitive electrode 308 and 318 comprises an elongate element formed of electrically conductive material. The conductive elements are in the form of generally rectangular, planar plates. Furthermore, in this embodiment, each induction coil 304, 310, 320 and 324 is an air core inductor. The hybrid resonators 306 and 316 are tuned to the resonant frequency of the receive induction coil 324. One of skill in the art will appreciate that the first hybrid resonator 306 may be integral with or separate from the transmitter 302. Similarly, the second hybrid resonator 316 may be integral with or separate from the receiver 322.

During operation, the current from the power source 305 causes the transmit induction coil 304 to generate a magnetic field. When the first induction coil 310 of the first hybrid resonator 306 is placed within the generated magnetic field, a current is induced in the first induction coil 310 thereby extracting power from the transmitter 302. The extracted power excites the first hybrid resonator 306 causing the first capacitive electrodes 308 and the first induction coil 310 to resonate. The first induction coil 310 in turn generates a resonant magnetic field. The first capacitive electrodes 308 in turn generate a resonant electric field. When the second hybrid resonator 316 is placed within the generated resonant magnetic field, the second induction coil 320 resonates thereby extracting power from the first hybrid resonator 306 via resonant magnetic field coupling. Similarly, when the second hybrid resonator 316 is placed with the generated resonant electric field, the second capacitive electrodes 318 resonate thereby extracting power form the first hybrid resonator 306 via resonant electric field coupling. The second induction coil 320 in turn generates a resonant magnetic field. When the receiver 322 is placed within the generated resonant magnetic field of the second hybrid resonator 316, a current is induced in the receive induction coil 324 thereby extracting power from the second hybrid resonator 316. The extracted power is then transferred from the receive induction coil 324 to the load 326.

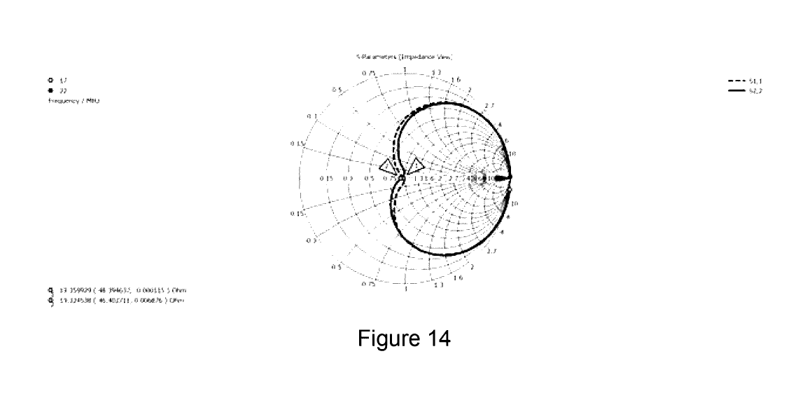

Electromagnetic field simulations using CST Microwave Studio software were performed to determine the impedance requirements of the wireless power transfer system 300 at a particular operating frequency. FIG. 14 shows the results of the electromagnetic field simulations for determining the impedance requirements of the system 300 at an operating frequency of approximately 19 MHz.

As shown in the Smith chart of FIG. 14, a frequency sweep from 17 to 22 MHz yields matched impedance between the transmitter 302 and receiver 322 in the electric and magnetic fields at the points marked 1 and 2. The lower impedance requirement from the Smith chart of FIG. 14 is at point 2 and is approximately 46 Ohms. The system 300 was configured such that this impedance was achieved.

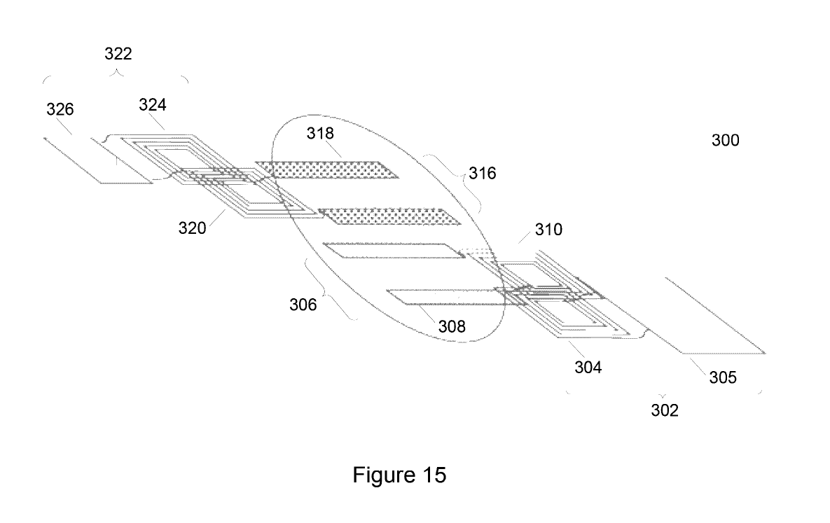

If the orientation of the transmitter 302, first hybrid resonator 306, second hybrid resonator 316, and receiver 322 is changed, the coupling between the system 300 components is affected. For example, as shown in FIG. 15, rotating the receiver 322 and second hybrid resonator 316 by 180 degrees causing coupling between the first and second hybrid resonators 306 and 316 to occur in only the electric field.

In this configuration, the current from the power source 305 causes the transmit induction coil 304 to generate a magnetic field. When the first induction coil 310 of the first hybrid resonator 306 is placed within the generated magnetic field, a current is induced in the first induction coil 310 thereby extracting power from the transmitter 302. The extracted power excites the first hybrid resonator 306 causing the first capacitive electrodes 308 and the first induction coil 310 to resonate. The first induction coil 310 generates a resonant magnetic field with the first capacitive electrodes 308 acting as a capacitor. Similarly, the first capacitive electrodes 308 generate a resonant electric field with the first induction coil 310 acting as an inductor.

When second hybrid resonator 316 is placed with the resonant electric field, the second capacitive electrodes 318 resonate thereby extracting power from the first hybrid resonator 306 via resonant electric field coupling. Since only the second capacitive electrodes 318 of the second hybrid resonator 316 are aligned with the first capacitive electrodes 308 of the first hybrid resonator 306 (not the first and second induction coil 310 and 320 of the first and second hybrid resonators 306 and 316, respectively), power is only extracted via resonant electric field coupling, not resonant magnetic field coupling.

Similar to the configuration shown in FIG. 13, the second induction coil 320 generates a resonant magnetic field with the second capacitive electrodes 318 acting as a capacitor. When the receiver 322 is placed within the generated resonant magnetic field of the second hybrid resonator 316, a current is induced in the receive induction coil 324 thereby extracting power from the second hybrid resonator 316. The extracted power is then transferred from the receive induction coil 324 to the load 326.

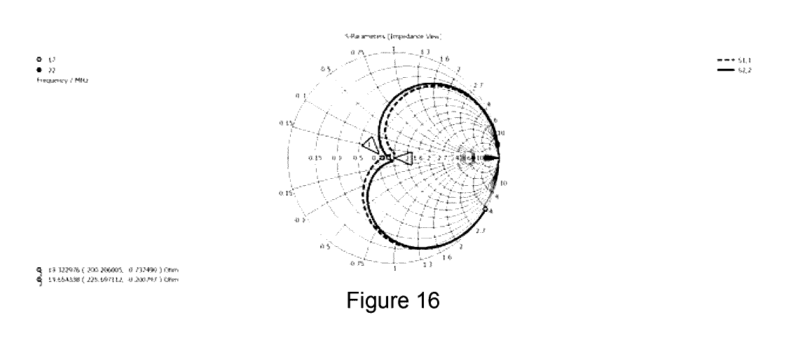

As shown in the Smith chart of FIG. 16, a frequency sweep from 17 to 22 MHz yields matched impedance of the system 300 shown in FIG. 15 in the electric field at the points marked 1 and 2. The lower impedance requirement from the Smith chart of FIG. 16 is at point 1 and is approximately 200 Ohms. The system 300 shown in FIG. 15 was configured such that this impedance was achieved.

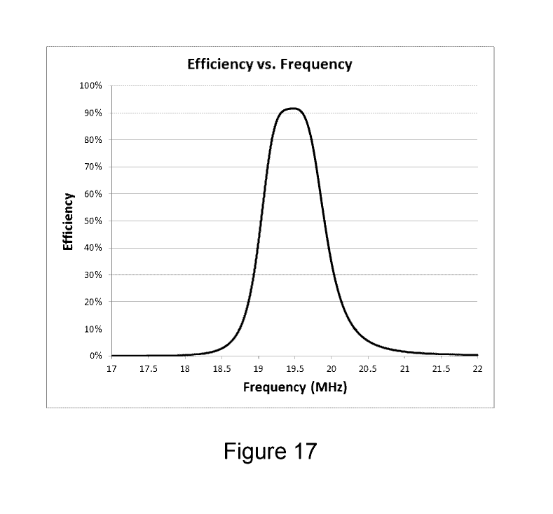

The efficiency of the power transfer of the system 300 shown in FIG. 15 is depicted in FIG. 17. Efficiency is maximized near 19.5 MHz.

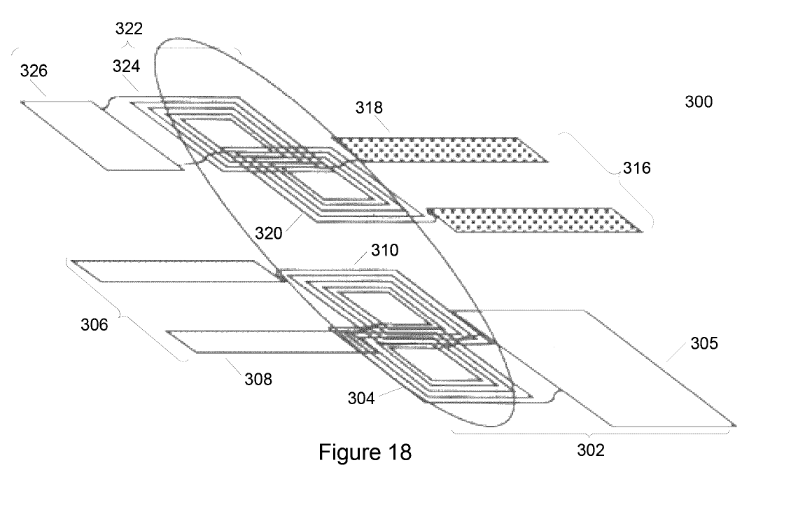

In another configuration, shown in FIG. 18, rotating the receiver 322 and second hybrid resonator 316 by negative 180 degrees causes coupling between the first and second hybrid resonators 306 and 316 to occur in only the magnetic field.

In this configuration, the current from the power source 305 causes the transmit induction coil 304 to generate a magnetic field. When the first induction coil 310 of the first hybrid resonator 306 is placed within the generated magnetic field, a current is induced in the first induction coil 310 thereby extracting power from the transmitter 302. The extracted power excites the first hybrid resonator 306 causing the first capacitive electrodes 308 and the first induction coil 310 to resonate. The first induction coil 310 generates a resonant magnetic field with the first capacitive electrodes 308 acting as a capacitor. Similarly, the first capacitive electrodes 308 generate a resonant electric field with the first induction coil 310 acting as an inductor.

When second hybrid resonator 316 is placed with the resonant magnetic field, the second induction coil 320 resonates thereby extracting power form the first hybrid resonator 306 via resonant magnetic field coupling. Since only the second induction coil 320 of the second hybrid resonator 316 are aligned with the first induction coil 310 of the first hybrid resonator 306 (not the first and second capacitive electrodes 308 and 318 of the first and second hybrid resonators 306 and 316, respectively), power is only extracted via resonant magnetic field coupling, not resonant electric field coupling.

Similar to the configuration shown in FIG. 13, the second induction coil 320 generates a resonant magnetic field with the second capacitive electrodes 318 acting as a capacitor. When the receiver 322 is placed within the generated resonant magnetic field of the second hybrid resonator 316, a current is induced in the receive induction coil 324 thereby extracting power from the second hybrid resonator 316. The extracted power is then transferred from the receive induction coil 324 to the load 326.

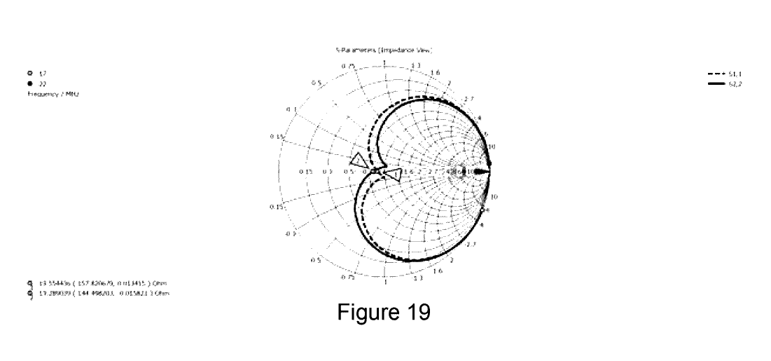

As shown in the Smith chart of FIG. 19, a frequency sweep from 17 to 22 MHz yields matched impedance of the system 300 shown in FIG. 18 in the magnetic field at the points marked 1 and 2. The lower impedance requirement from the Smith chart of FIG. 19 is at point 2 and is approximately 144 Ohms. The system 300 shown in FIG. 18 was configured such that this impedance was achieved.

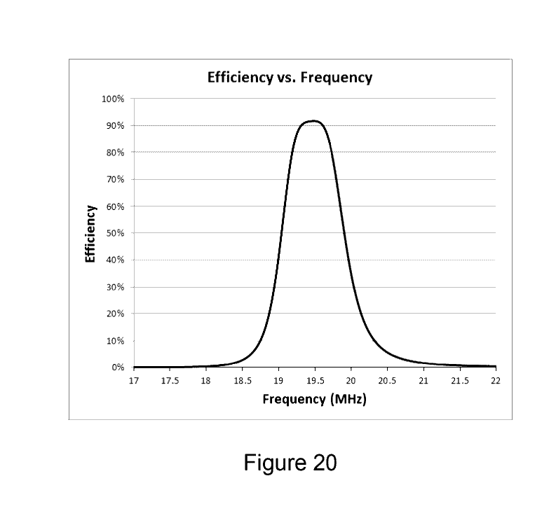

The efficiency of the power transfer of the system 300 shown in FIG. 18 is depicted in FIG. 20. Efficiency is maximized near 19.5 MHz.

While the system 300 has been shown in FIGS. 13, 15 and 18 with the transmitter 302, first hybrid resonator 306, second hybrid resonator 316 and receiver 322 in parallel planes, one of skill in the art will appreciate that other orientations are possible, including, but not limited to the transmitter 302 being perpendicular to the receiver 322, the transmitter 302 being perpendicular to the first hybrid resonator 306, the first hybrid resonator 306 being perpendicular to the second hybrid resonator 316, the second hybrid resonator 316 being perpendicular to the receiver 322 and combinations thereof.

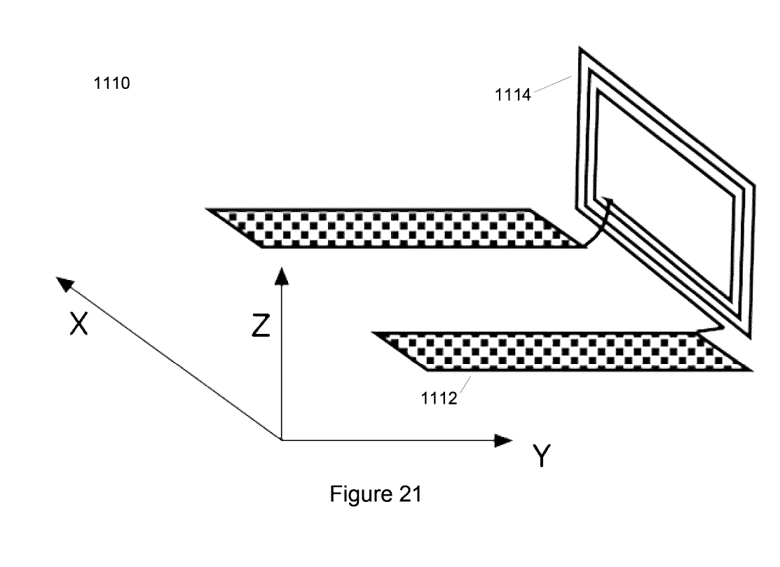

While FIGS. 6, 7, 9, 11, 12, 13, 15 and 18 show a hybrid resonator 200 comprising capacitive electrodes 202 and an induction coil 204 that are in the same plane, those of skill in the art will appreciate that other configurations are possible. For example the capacitive electrodes and induction coil may be in different planes. As shown in FIG. 21, a hybrid resonator 1110 comprises capacitive electrodes 1112 which are electrically connected to either end of an induction coil 1114. In this embodiment, the capacitive electrodes 1112 are in the x-y plane while the induction coil 1114 is in the x-z plane.

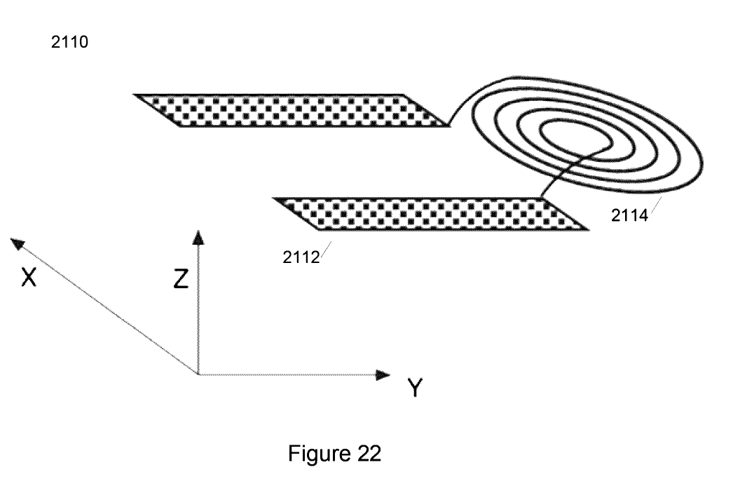

Furthermore, while FIG. 6 shows an induction coil 114 that has a generally rectangular shape, those of skill in the art will appreciate that other shapes are possible. As shown in FIG. 22, a hybrid resonator 2110 comprises capacitive electrodes 2112 which are electrically connected to either end of an induction coil 2114. In this embodiment, the induction coil 2114 has a generally circular shape. Furthermore, other shapes are possible. For example, the induction coil may have a generally circular, hexagonal or octagonal shape.

In one embodiment, the various power sources described are RF power sources. In another embodiment, the various power sources described are alternating power sources. Furthermore, while the induction coils have been described as air core inductors, one of skill in the art will appreciate that other cores may be used, such as a ferrite core, an iron core, or a laminated-core.

Although embodiments have been described above with reference to the figures, those of skill in the art will appreciate that variations and modifications may be made without departing from the scope thereof as defined by the appended claims.

What is claimed is:

1. A hybrid resonator comprising:
capacitive electrodes; and
an induction coil electrically connected to the capacitive electrodes, wherein the capacitive electrodes and the induction coil are configured to:
responsive to a generated field, extract power from the generated field; and
responsive to the extracted power, generate a field.

2. The hybrid resonator of claim 1, wherein the induction coil is an air core inductor.

3. The hybrid resonator of claim 1, wherein the capacitive electrodes act as a capacitor.

4. The hybrid resonator of claim 1, wherein the capacitive electrodes are two laterally spaced electrodes, each of which is connected to either end of the induction coil.

5. The hybrid resonator of claim 1, wherein the generated field is a magnetic field.

6. The hybrid resonator of claim 1, wherein the generated field is an electric field.

7. The hybrid resonator of claim 1, wherein the field generated by the hybrid resonator is a resonant magnetic field.

8. The hybrid resonator of claim 1, wherein the field generated by the hybrid resonator is a resonant electric field.

9. A wireless power system comprising:
a field-generator for generating a field;
a hybrid resonator comprising:
capacitive electrodes; and
an induction coil electrically connected to the capacitive electrodes, wherein the capacitive electrodes and the induction coil are configured to:
responsive to the generated field, extract power from the generated field; and
responsive to the extracted power, generate a field; and
a field-extractor for extracting power from the field generated by the hybrid resonator.

10. The wireless power system of claim 9, wherein the induction coil is an air core inductor.

11. The wireless power system of claim 9, wherein the capacitive electrodes act as a capacitor.

12. The wireless power system of claim 9, wherein the capacitive electrodes are two laterally spaced electrodes, each of which is connected to either end of the induction coil.

13. The wireless power system of claim 9, wherein the field-generator generates a magnetic field.

14. The wireless power system of claim 13, wherein the field-generator comprises:
a power source; and
an induction coil electrically connected to the power source.

15. The wireless power system of claim 9, wherein the field-generator generates an electric field.

16. The wireless power system of claim 15, wherein the field-generator comprises:
a power source; and
laterally spaced electrodes electrically connected to the power source.

17. The wireless power system of claim 9, wherein the field generated by the hybrid resonator is a resonant magnetic field, a resonant electric field, a magnetic field and/or an electric field.

18. A transmitter comprising:
a field-generator for generating a field; and
a hybrid resonator comprising:
capacitive electrodes; and
an induction coil electrically connected to the capacitive electrodes, wherein the capacitive electrodes and the induction coil are configured to:
responsive to the generated field, extract power from the generated field; and
responsive to the extracted power, generated a field.

19. A receiver comprising:
a hybrid resonator comprising:
capacitive electrodes; and
an induction coil electrically connected to the capacitive electrodes, wherein the capacitive electrodes and the induction coil are configured to:
responsive to a generated field, extract power from the generated field; and
responsive to the extracted power, generated a field; and
a field-extractor for extracting power from the field generated by the hybrid resonator.

20. A resonator configured to extract and transfer power via electric and magnetic field coupling.
